(19) United States
(12) Patent Application Publication
(10) Pub. No.: US 2012/0177809 A1
(43) Pub. Date: Jul. 12, 2012

(54) DUCT COATING SYSTEM

(76) Inventors: JOHN B. SOLIE, Stillwater, OK (US); MARVIN L. STONE, Stillwater, OK (US); EVANDER EVANS CHAMBERS, Idaho Falls, ID (US)

(21) Appl. No.: 13/004,333

(22) Filed: Jan. 11, 2011

(51) Int. Cl. B05B 13/06; B05D 7/22; B05B 12/00; B05D 1/02; B05B 1/00; B05B 15/00

(52) U.S. Cl. 427/8; 427/401; 118/306; 118/612; 118/713; 118/696; 118/668

(57) ABSTRACT

A method of sealing pipes or ducts with a duct coating applicator having a camera mounted thereon. The duct coating applicator sprays plural compounds on an interior of the duct. A duct coating applicator mounted camera records a video of an inside of the duct. The video is quickly accessible for customer review on site. A customer billing statement is quickly generated on site. A controller communicates with the nozzle carriage. A pump feeds the duct coating applicator from a resin tank via a resin supply line. The controller receives resin temperature and pressure, duct diameter, and duct coating applicator speed data and can adjust resin feed and duct coating applicator speed rates. The duct coating applicator has a cylindrical body having an outer member and a core member. An adjustable nozzle is on an outlet end for dispersing resin. Extension arms may be adjusted to accommodate various duct sizes.

### STATEMENT REGARDING FEDERALLY SPONSORED RESEARCH OR DEVELOPMENT

This invention was made with U.S. Government support under grant number NSF Grant No. EEC-0332723 awarded by the National Science Foundation. The Government has certain rights in this invention.

### FIELD OF THE INVENTION

The invention relates to a device and system for coating pipes and ducts. In particular, the device of the invention utilizes a duct coating applicator capable of navigating small ducts and is used with a system that provides data to an operator and to a remote recipient.

### BACKGROUND OF THE INVENTION

There are numerous patents and publications describing devices and systems purporting to inspect, repair, and seal pipes and ducts. However none of these devices and systems can navigate and treat small (e.g., 6 inch in diameter) HVAC ducts with elbows and transitions. In addition, none of these devices have been packaged in systems that enable regional and national franchising. This disclosure describes a device and system to meet the objectives.

### SUMMARY OF THE INVENTION

The duct coating system uses a self-propelled remotely operated tracked or wheeled vehicle (ROV) to conduct initial and final inspections and to video record those inspections of a duct interior. Preferably, a camera is also placed on the applicator head of the duct coating applicator to monitor the coating process and to track the location of the application head. This is particularly important when applying additional coats of material at specific locations in a duct.

The applicator of the duct coating system is preferably passive, i.e., towed. The duct coating applicator may be provided with a scissor-type carriage or, alternatively, may be mounted on an ROV similar to the inspection ROV to position the nozzle and to assist the capstan or winch in propelling the duct coating applicator through the duct.

The ROV may also be used to string a tow line through the duct to be attached to the applicator head. The tow line is used to pull the applicator head and material supply lines through the duct prior to coating the duct. The duct coating applicator of the invention is preferably a towed device that conveys a dynamic mixer for plural compounds, and a metering nozzle capable of uniformly coating the inside of the duct/pipe. The duct coating applicator can transport a single component nozzle for priming the duct, cameras for inspecting the duct, and devices to scarify the walls of the duct. The duct coating applicator can also convey an orientable nozzle to repair holes in the duct by injecting plural fluid compounds into cavities.

The plural fluid nozzle and transporter works as follows. The duct coating applicator consists of a cylindrical body to which are attached four 4-bar extendable arms with wheels. These arms can extend or contract to follow the inside of a duct or pipe while positioning the body in the center of the duct. An annular air cylinder contracts or extends the arms. The cylinder is counterbalanced by a set of extension springs to control the forces exerted by the wheel against the wall of the duct. In an alternative version, springs extend the arms and arms are contracted manually.

The duct coating system of the invention is a three fluid system, e.g., air, resin, and, in the case of polyurea, isocyanate. Preferably, the flow rates of each pump of the resin and isocyanate may be separately controlled because of the large ranges in viscosity of the two materials as a function of temperature. The two parts of the plural fluid are metered separately into the rear of the nozzle system. The two parts of the fluid are combined by impinging the two streams. Further mixing occurs in the slotted or round orifices. An adjustable nozzle produces a cone shaped pattern or radial fan shaped pattern of the mixed materials to coat the inside of the duct. Viscosity is controlled by resistance heaters (not shown). The transporter is towed through the duct by its supply hoses with speed controlled by a capstan (not shown). Servos controlled by a central computer drive the capstan plural fluid pumps, transporter arm, heaters, and other devices in the system. The system of the invention is capable of conveying a nozzle through HVAC ducts of a variety of sizes. The system facilitates mixing, atomizing, and applying plural compounds to seal and provide structural integrity to the duct. The duct coating system provides a means to inspect, clean, prepare, prime, coat, and document the sealing process. The system also provides a means to repair and disinfect a duct/pipe installation.

The duct coating system includes the capacity to transmit to a franchiser and franchisee statistics obtained during the sealing of a duct system in a home. This feature provides for the ability for automated accounting and billing for a franchisee and franchiser.

### BRIEF DESCRIPTION OF THE DRAWINGS

FIG. 1 is a partial sectional drawing of a transport and plural fluid nozzle.

FIG. 2 shows the transport and plural product nozzle of FIG. 1 navigating a 6 inch duct 90 degree elbow.

FIG. 3 shows a transporter and plural product nozzle with guide wheel arm expanded to navigate 10 inch diameter ducts.

FIG. 4 shows the transporter of the invention in two configurations.

FIG. 5 shows steps for a method of use of the duct coating system of the invention.

FIG. 6 is a block diagram of a computer controlled application system and a motion control system to allow a plural component nozzle transporter to be positioned in the duct.

FIG. 7 is a controller block diagram for the duct coating system of the invention.

### DETAILED DESCRIPTION OF THE PREFERRED EMBODIMENTS

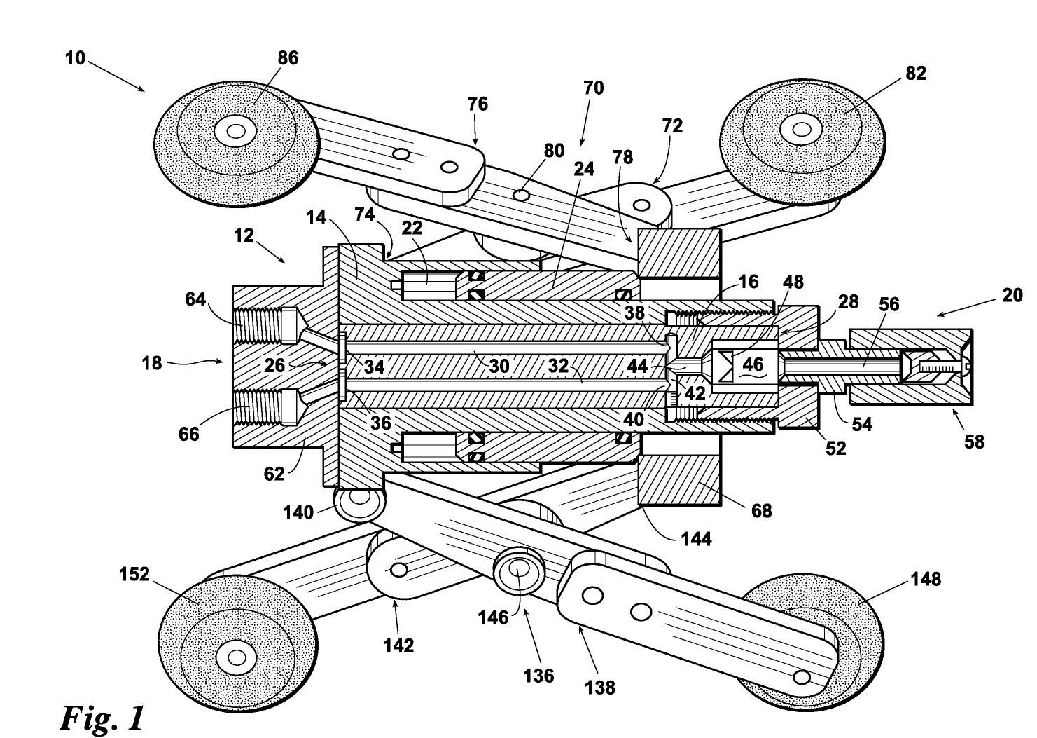

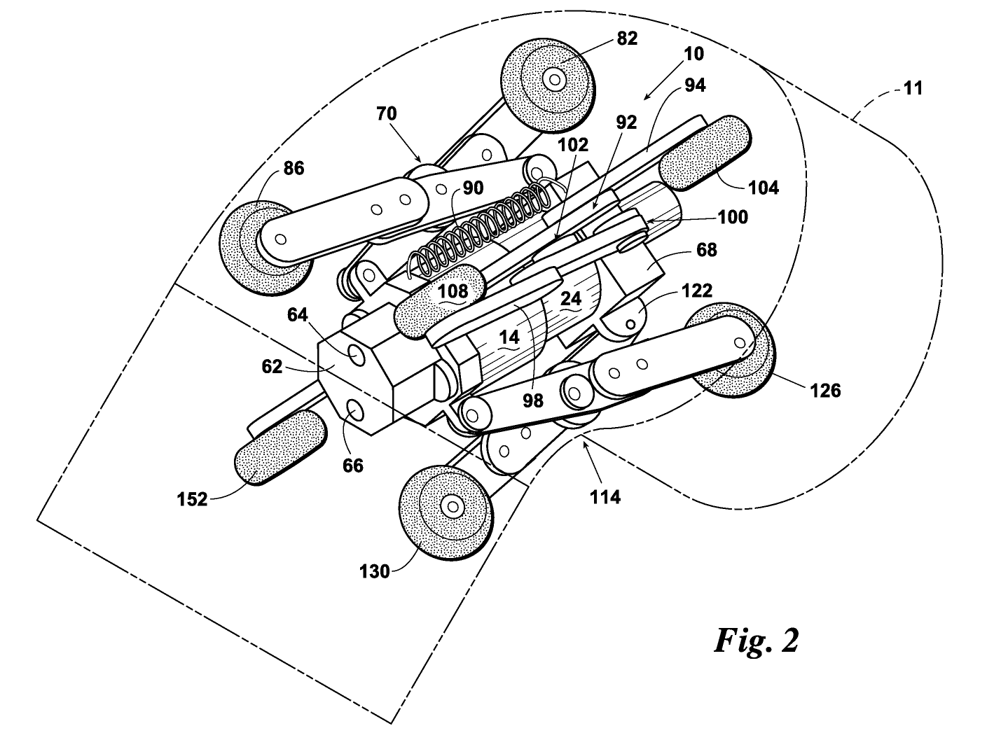

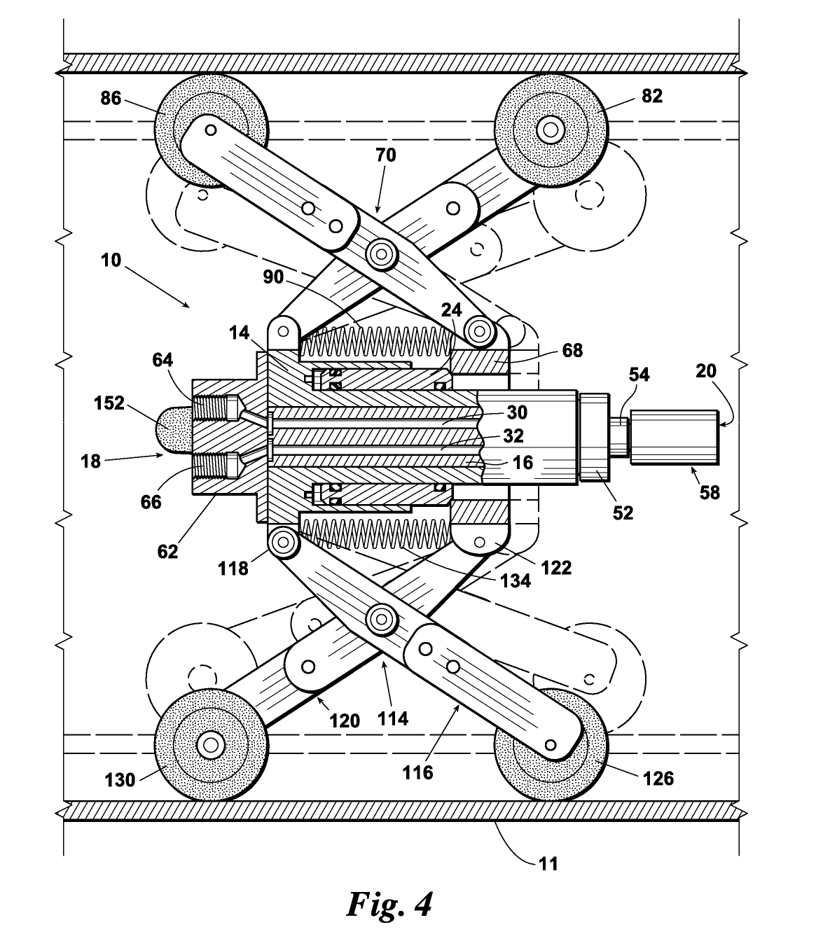

Referring now to FIGS. 1 and 2, shown is a duct coating applicator or applicator head of the invention designated generally 10. Duct coating applicator 10 is a towed device that is capable of navigating a duct 11 (FIGS. 2, 4). Duct 11 may be of various sizes, e.g., 6 inch ducts, duct elbows, transitioning and wyes. Duct coating applicator 10 is capable of expanding for use in larger ducts, e.g., 10 to 12 inch diameter duct systems. Duct coating applicator 10 has a cylindrical body 12. Cylindrical body 12 has an outer member 14 and a core member 16. Cylindrical body 12 additionally has an inlet end 18 and an outlet end 20. Outer member 14 defines an annular chamber 22 (FIG. 1) for receiving an annular piston 24 for regulating extension of pairs of extension arms 70, 92, 114, 136, discussed below. Core member 16 has an inlet end 26 and an outlet end 28 (FIG. 1). Core member 16 defines a first longitudinal passageway 30 and a second longitudinal passageway 32. First longitudinal passageway 30 has a first inlet 34 and second longitudinal passageway 32 has a second inlet 36. Each of first inlet 34 and second inlet 36 communicate with inlet end 26 of core member 16. First passageway 30 has a first outlet 38. Second passageway 32 has a second outlet 40. Each of first outlet 38 and second outlet 40 communicate with transverse combining passageway 42. Transverse combining passageway 42 passes combined fluids to impinging mixing chamber 44 for passing fluid through a slotted or radially drilled orifice core mixer 46.

Slotted member 48 is located in slotted core mixer 46 adjacent to an outlet end of impinging mixing chamber 44.

Outlet cap 52 is threadably received on outlet end 28 of core member 16. Outlet cap 52 receives stem 54 that defines exit passageway 56.

Adjustable nozzle 58 is positioned on an outlet end of stem 54 for dispersing fluids traveling through exit passageway 56.

Inlet member 62 is affixed to inlet end 18 of cylindrical body 12. Inlet member 62 defines first threaded inlet 64 and second threaded inlet 66. First threaded inlet 64 communicates with inlet 34 of first longitudinal passageway 30. First threaded inlet 64 receives a first component of a plural fluid. Second threaded inlet 66 is in communication with second inlet 36 of second longitudinal passageway 32. Second threaded inlet 66 receives a second component of a plural fluid.

Slider 68 is slidably received on and surrounds outer member 14. Slider 68 interacts with annular piston 24 for being longitudinally displaced thereby.

First pair of extension arms 70 has a first arm 72 having a proximate end 74 pivotally affixed adjacent to inlet end 18 of cylindrical body 12. First pair of extension arms 70 has a second arm 76 having a proximate end 78 pivotally affixed to extension slider 68. First arm 72 and second arm 76 of first pair of extension arms 70 are pivotally affixed to one another at point 80 located approximately at a midpoint of each of first arm 72 and second arm 76.

First wheel 82 is affixed to a distal end of first arm 72, and second wheel 86 is affixed to a distal end of second arm 76 of first pair of extension arms 70. First extension spring 90 has a first end affixed to outer member 14 and a second end affixed to extension slider 68 for biasing extension slider 68 toward inlet end 18 of cylindrical body 12, thereby biasing first wheel 82 and second wheel 86 away from cylindrical body 12 via scissor action of first arm 72 and second arm 76.

Second pair of extension arms 92 has a third arm 94 having a proximate end 96 pivotally affixed to inlet end 18 of cylindrical body 12. Second pair of extension arms 92 has a fourth arm 98 having a proximate end 100 pivotally affixed to extension slider 68. Third arm 94 and fourth arm 98 of second pair of extension arms 92 are pivotally affixed to one another at point 102 located approximately at a midpoint of each of third arm 94 and fourth arm 98. Third wheel 104 is affixed to a distal end of third arm 94 and a fourth wheel 108 is affixed to a distal end of fourth arm 98 of second pair of extension arms 92.

A third pair of extension arms 114 has a fifth arm 116 having a proximate end 118 pivotally affixed to inlet end 18 of cylindrical body 12. Third pair of extension arms 114 has a sixth arm 120 having a proximate end 122 pivotally affixed to extension slider 68. Fifth arm 116 and sixth arm 120 of third pair of extension arms 114 are pivotally affixed to one another at point 124 proximate a midpoint of each of fifth arm 116 and sixth arm 120. Fifth wheel 126 is affixed to a distal end of fifth arm 116 and sixth wheel 130 is pivotally affixed to sixth arm 120 of the third pair of extension arms 114.

Second extension spring 134 (FIG. 4) has a first end affixed to outer member 14 and a second end affixed to extension slider 68 for biasing extension slider 68 toward inlet end 18 of cylindrical body 12, thereby biasing fifth wheel 126 and sixth wheel 130 away from cylindrical body 12 via scissor action of fifth arm 116 and sixth arm 120.

A fourth pair of extension arms 136 has a fifth arm 138 having a proximate end 140 pivotally affixed to inlet end 18 of cylindrical body 12. Fourth pair of extension arms 136 has a sixth arm 142 having a proximate end 144 pivotally affixed to extension slider 68. Fifth arm 138 and sixth arm 142 of fourth pair of extension arms 136 are pivotally affixed to one another at point 146 proximate a midpoint of each of fifth arm 138 and sixth arm 142. Fifth wheel 148 is affixed to a distal end of fifth arm 138 and sixth wheel 152 is pivotally affixed to sixth arm 142 of the fourth pair of extension arms 136.

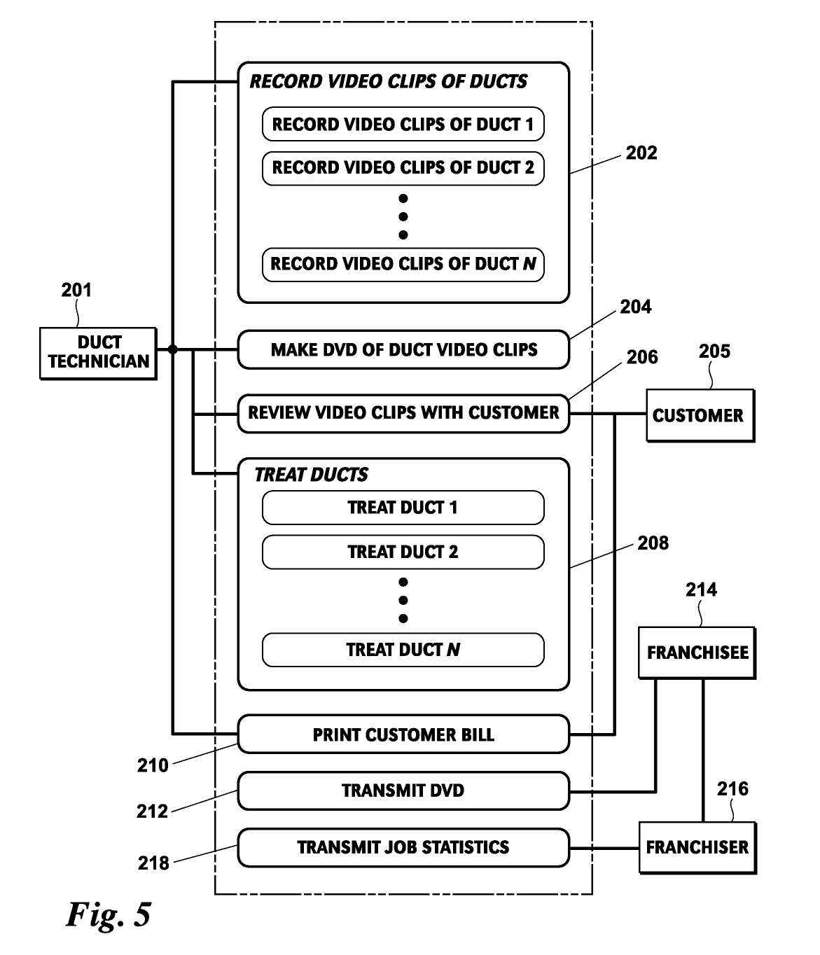

FIG. 5 is a block diagram of the electronics and control system. The elements in the system describe some of its functionality. The block diagram shows a computer controlled application system and a motion control system to allow the plural component nozzle and transporter to be positioned in the duct.

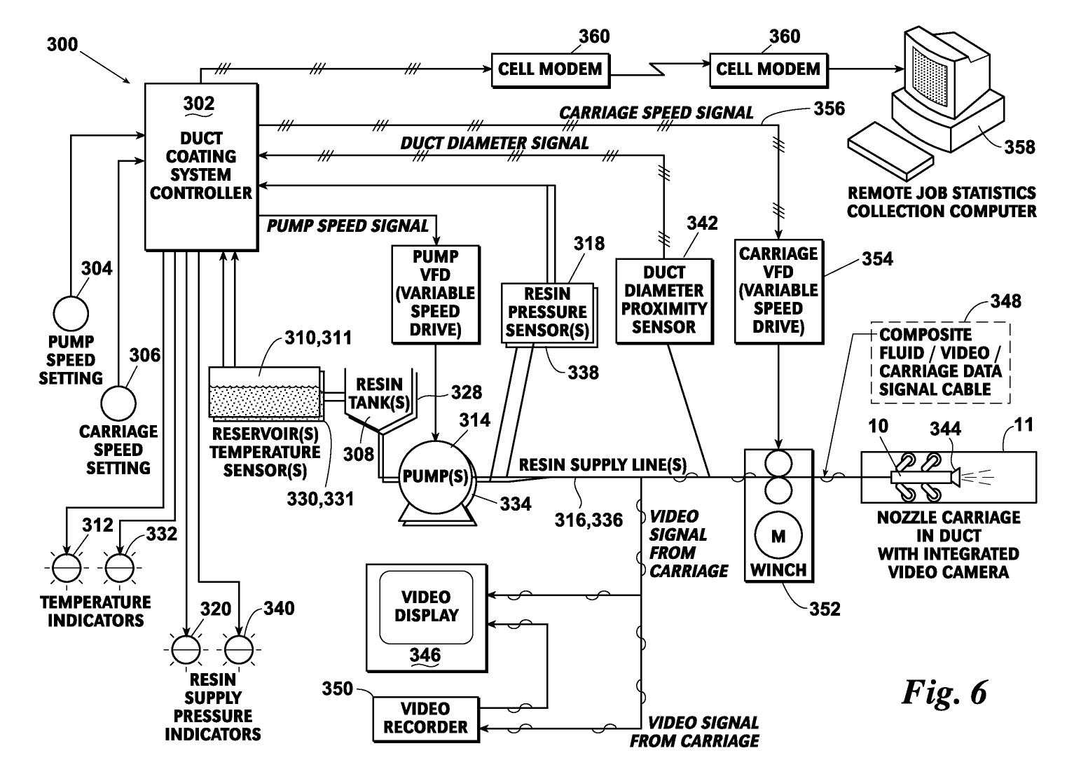

Referring now to FIG. 5, in practice, the method of sealing pipes or ducts comprises the steps of mounting video camera 344 (FIG. 6) on duct coating applicator 10. Duct technician 201 moves duct coating applicator 10 through duct 11, recording a video of an inside of duct 11, as shown in step 202. The video information is then transferred and stored onto a storage medium, as shown in step 204. The video recording is then reviewed with customer 205, as shown in step 206. Duct coating applicator 10 may then be moved through duct 11 for spraying plural compounds on an interior of duct 11 for sealing and providing structural integrity to duct 11 as shown in step 208. A bill may then be printed at the duct location for the customer as shown in step 210. The video recording is then transmitted to a remotely located franchisee and franchisor as shown in step 212. Job statistics are additionally transmitted to the local franchisee 214 and to the franchiser 216, as shown in step 218.

The duct coating applicator 10 may be of the type disclosed in U.S. patent application Ser. No. 12/723,425 entitled “Mixing Nozzle for Plural Component Materials,” which is hereby incorporated by reference.

Referring now to FIG. 6, shown is duct coating system 300. Duct coating system 300 includes a duct coating applicator 10 and controller 302. A pump speed setting 304 is provided on controller 302 for adjusting the pump speed. Carriage speed setting 306 is provided on controller 302 for adjusting the travel speed of duct coating applicator 10 within duct 11.

First resin tank 308 is provided for receiving a quantity of a first resin. First reservoir 310 is in communication with and receives resin from first resin tank 308. First reservoir temperature sensor 330 is provided to read temperature of the resin in first resin tank 308. First temperature sensor 330 communicates temperature data with controller 302. First temperature indicator 312 is provided on controller 302 for indicating temperature of the resin in first resin tank 308.

First pump 314 communicates with first resin tank 308 for receiving resin therefrom. First resin supply line 316 is provided for receiving resin from first pump 314 and for delivering resin to duct coating applicator 10. First resin pressure sensor 318 communicates with first resin supply line 316 for measuring pressure in first resin supply line 316. First resin pressure sensor 318 communicates pressure data to controller 302. First resin supply pressure indicator 320 indicates the pressure readings of second resin pressure sensor 318 as instructed by controller 302.

Second resin tank 328 is provided for receiving a quantity of a second resin. Second reservoir 311 is in communication with and receives resin from second resin tank 328. Second reservoir temperature sensor 331 is provided to read temperature of the resin in second resin tank 328. Second temperature sensor 331 communicates temperature data with controller 302. Second temperature indicator 332 is provided on controller 302 for indicating temperature of the resin in second resin tank 328.

Second pump 334 communicates with second resin tank 328 for receiving resin therefrom. Second resin supply line 336 is provided for receiving resin from second pump 334 and for delivering resin to duct coating applicator 10. Second resin pressure sensor 338 communicates with second resin supply line 336 for measuring pressure in second resin supply line 336. Second resin pressure sensor 338 communicates pressure data to controller 302. Second resin supply pressure indicator 340 indicates the pressure readings of second resin pressure sensor 338 as instructed by controller 302.

Duct diameter proximity sensor 342 is provided on duct coating applicator 10 for measuring a diameter of duct 11 through which duct coating applicator 10 is traversing. Duct diameter proximity sensor 342 is in communication with controller 302.

Video camera 344 is located on duct coating applicator 10. Video display 346 is provided for receiving video signal from video camera 344 on duct coating applicator 10 via a data signal cable 348. Video recorder 350 is in communication with video display 346 and with data signal cable 348.

Winch 352 engages first resin supply line 316, second resin supply line 336 and data signal cable 348 for pulling duct coating applicator 10 through duct 11. Carriage variable speed drive 354 is in communication with winch 352 for directing a speed with which winch 352 pulls duct coating applicator 10. Carriage variable speed drive 354 receives a carriage speed signal 356 from controller 302.

A remote jobs statistics collection computer 358 is provided at a location remote from duct coating applicator 10 and controller 302. An external communicator, such as cell modem 360, is in communication with controller 302 for passing job statistics to remote jobs statistics collection computer 358.

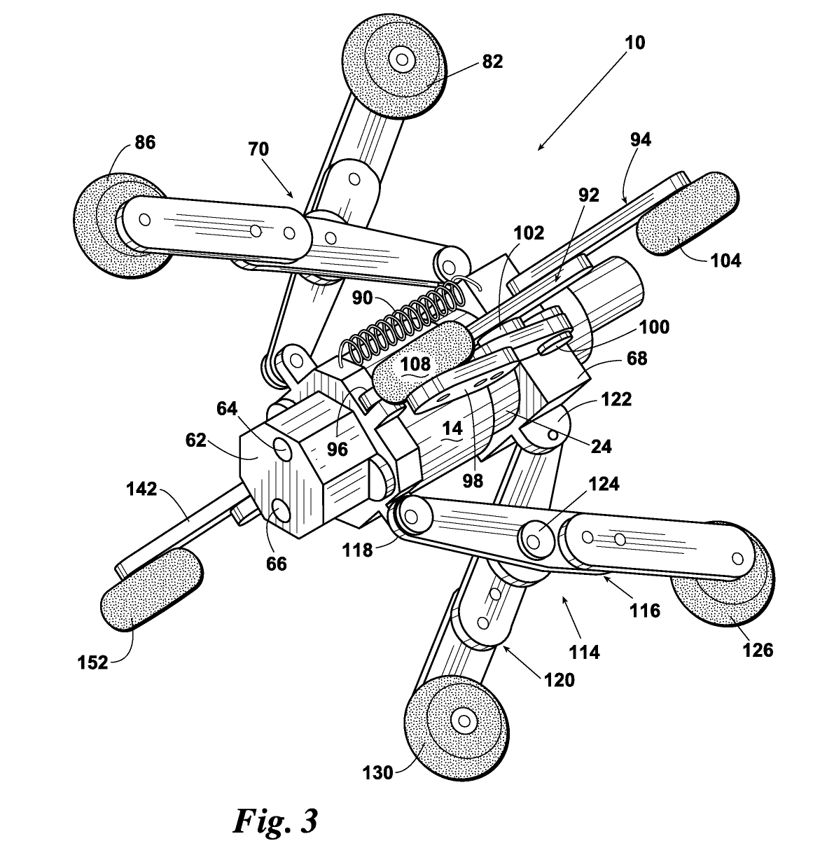

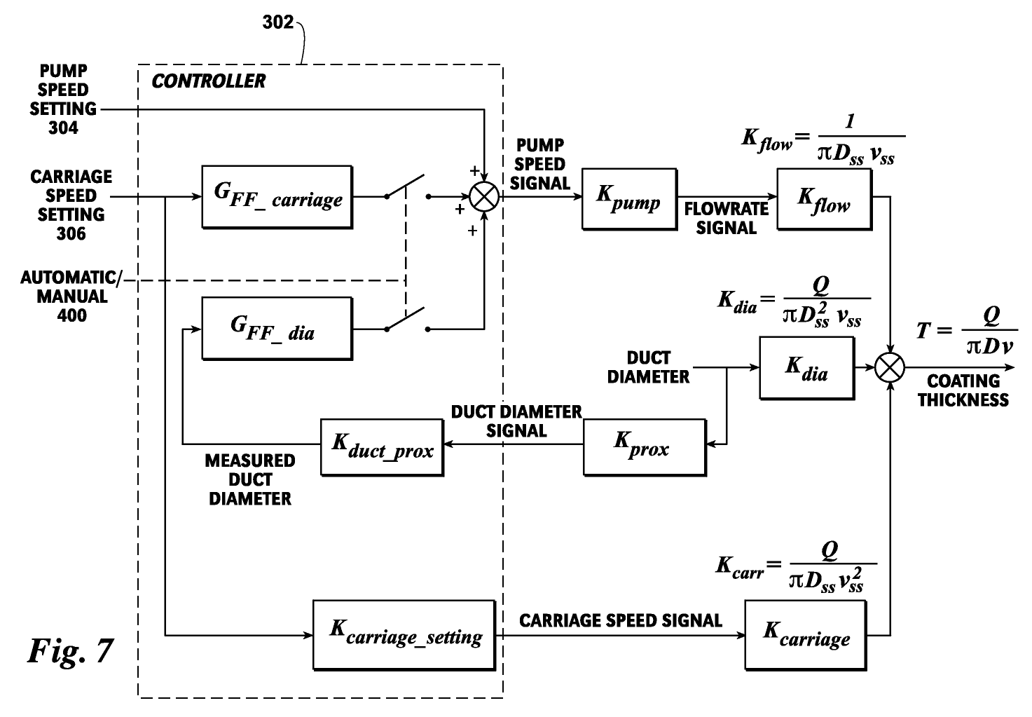

Referring now to FIG. 7, controller 302, also shown in FIG. 6, is provided wherein a user may input pump speed setting 304 (see also FIG. 6) and a carriage speed setting 306 (see also FIG. 6) and may select between automatic or manual setting 400. Duct coating applicator 10 (FIGS. 1-5) may be provided with a duct diameter measuring device, e.g., duct diameter proximity sensor 342 (FIG. 6). Duct coating applicator 10 is additionally provided with a transmitter so that a duct diameter may be transmitted to controller 302 when automatic/manual setting 400 of controller 302 is set for automatic operation.

The overall methodology of the controller 302 is that of a feed forward system. In FIG. 6 it can be seen that user inputs may be provided to or by the controller 302. Control operations occur within the controller 302 that are then passed out of the controller to duct coating applicator 10. The behavior of duct coating applicator 10 may be modeled by the system illustrated to the right side of controller 302 in FIG. 7. Based in part upon signals received back from the duct coating applicator 10, the control outputs can be modified by the controller 302 as needed. In actuality, changes implemented by the controller 302 will not occur instantaneously throughout the rest of the system. However, given the relatively small size and speed of the duct coating applicator, and relatively small volume of the pump, it is appropriate in some embodiments to consider the system statically as shown in FIG. 7.

In operation of the present embodiment, a signal from the pump speed setting 304 is summed with a G_{FF}_{_{—}}_{carriage} signal, which is derived in part based on the carriage speed setting 306 as described below. These signals are also summed with a G_{FF}_{_{—}}_{dia} signal, which is derived from the duct diameter, and also described below. The result of this summation is the Pump Speed Signal from the control system 302. The Pump speed signal Kₚᵤₘₚ can be considered as a flow rate signal K_{flow} governed by the equation K_{flow}=1/πDₛₛvₛₛ. Here Dₛₛ is the pipe diameter and Vₛₛ is the velocity of the duct coating applicator 10 in the pipe or duct. Hence, for a constant coating thickness, the flow rate is inversely proportional to the diameter and velocity.

The flow rate signal K_{flow} is summed with the duct diameter as K_{dia}, which follows the equation K_{dia}=−Q/πD²ₛₛvₛₛ. Here Q is the volumetric flow rate. Hence, to maintain a constant coating thickness T, the volumetric flow rate Q must remain in proportion to the product of the diameter squared and the velocity. In the present system, the actual measured duct diameter is reported to the controller 302 by the duct coating applicator 10. This measurement is scaled by a feed forward gain factor G_{FF}_{_{—}}_{dia} to account for changes in the pipe diameter as the duct coating applicator 10 moves. When the system is in automatic mode, this factor will be utilized to control the pump speed signal thus feeding forward through the system.

In producing a thickness of coating T, K_{flow} and K_{dia} are summed with K_{carr} or K_{carriage} which follows the following equation: K_{carr}=−1/πDₛₛv²ₛₛ. K_{carr} is a carriage speed signal from the controller 302. Thus it will be appreciated that carriage speed, as relating to thickness T, is directly proportional to volumetric flow and inversely proportional to diameter and velocity. The final thickness T may be computed from the system using the equation T=Q/πDv.

Based on the foregoing, it will be appreciated that in operation both the pump speed and carriage speed may be controlled by the controller 302 to produce a uniform and desired coating thickness T. In the present embodiment, the carriage speed signal is produced by the controller 302 and fed to duct coating applicator 10. The pump speed is derived based upon the carriage speed to produce the proper flow rate for the desired thickness. Since the speed is controlled by controller 302 it will be known (assuming adequate traction and correct mechanical operation of the controller 302) and can be fed into G_{FF}_{_{—}}_{carriage}, which is a feed forward gain factor. This factor can account for changes in the speed of duct coating applicator 10 determined from the carriage speed setting 306. The provided duct diameter signal provided back to controller 302 from duct coating applicator 10 scaled by the feed forward factor G_{FF}_{_{—}}_{dia} to account for duct diameter changes as well.

Through the feed forward mechanisms just described, combined with user inputs, controller 302 controls the pump speed and carriage speed to create the desired thickness T of the applied coating. It will be appreciated that controller 302 must have the correct forward gain factors G_{FF}_{_{—}}_{carriage} and G_{FF}_{_{—}}_{dia}. These may be derived based upon computations based on known factors, such as thickness T, nominal pipe diameter, and projected speed of the carriage. However, in some embodiments, it may be faster and more convenient to determine them empirically through testing. The gain factors can then be programmed into, or provided to, controller 302.

The controller 302 may be implemented in hardware, software, or a combination. A graphical interface could be designed that allows a user to enter parameters and to start and stop the operation of the duct coating applicator 10. In other embodiments, a selection of switches and dials may be arranged on a control box. In this case, a user may dial in or select for parameters and modes of operation. The underlying control hardware could be a general purpose microcontroller, an application specific integrated circuit, or various computers on a chip that may also incorporate I/O ports for sending the control signals to the duct coating applicator 10.

Thus, the present invention is well adapted to carry out the objectives and attain the ends and advantages mentioned above as well as those inherent therein. While presently preferred embodiments have been described for purposes of this disclosure, numerous changes and modifications will be apparent to those of ordinary skill in the art. Such changes and modifications are encompassed within the spirit of this invention as defined by the claims.

What is claimed is:

1. A method of sealing pipes or ducts comprising the steps of:
mounting a camera on a duct coating applicator;
moving said duct coating applicator through a duct for spraying plural compounds on an interior of said duct for sealing and providing structural integrity to said duct;
recording a video of an inside of said duct;
reviewing said video with a customer proximate to a location of said duct and proximate in time to said step of recording.

2. The method according to claim 1 further comprising the step of:
transferring said video onto a storage medium.

3. The method according to claim 1 further comprising the step of:
printing a billing statement for said customer proximate to said location of said duct and proximate in time to said step of recording.

4. The method according to claim 1 further comprising the steps of:
transmitting said video to a remotely located franchisee and franchisor proximate in time to said step of recording;
transmitting job statistics to said remotely located franchisee and franchisor proximate in time to said step of recording.

5. The method of claim 1, further comprising:
providing a controller for signaling a flow rate for said compounds and for signaling a speed for said duct coating applicator, said controller implementing a feed forward system that adjusts said flow rate based on said speed for said duct coating applicator and a duct diameter measured by said duct coating applicator.

6. A duct coating applicator comprising:
a cylindrical body having a outer member and a core member and having an inlet end and an outlet end;
said outer member defining an annular chamber for receiving an annular piston;
said core member having in inlet end and an outlet end,
an outlet cap threadably received on said outlet end of said core member, said outlet cap having a stem defining an exit passageway;
an adjustable nozzle on an outlet end of said stem of said outlet cap for dispersing fluids traveling through said exit passageway;
an extension slider slidably received on and surrounding said outer member, said extension slider affixed to said annular piston for being longitudinally displaced thereby;
a pair of extension arms having a first arm having a proximate end pivotally affixed to said inlet end of said cylindrical body, said pair of extension arms having a second arm having a proximate end pivotally affixed to said extension slider, said first arm and said second arm of said pair of extension arms pivotally affixed to one another proximate a midpoint of each of said first arm and said second arm.

7. The duct coating applicator according to claim 6 wherein:
said cylindrical body defines a first longitudinal passageway and a second longitudinal passageway, a transverse combining passageway, a central passageway and an impinging mixing chamber;
said first longitudinal passageway having an inlet in communication with said inlet end of said core member and an outlet at said transverse combining passageway;
said second longitudinal passageway having an inlet in communication with said inlet end of said core member and an outlet at said transverse combining passageway;
said transverse combining passageway for passing combined fluids to said central passageway for passing fluid to said impinging mixing chamber.

8. The duct coating applicator according to claim 7 further comprising:
an impinging member in said impinging mixing chamber adjacent to an outlet end of said central passageway.

9. The duct coating applicator according to claim 7 further comprising:
an inlet member affixed to said inlet end of said cylindrical body, said inlet member defining a first threaded inlet and a second threaded inlet, said first threaded inlet in communication with said inlet of said first longitudinal passageway and a second threaded inlet in communication with said inlet of said second longitudinal passageway.

10. The duct coating applicator according to claim 6 further comprising:
a video camera mounted on said cylindrical body.

11. The duct coating applicator according to claim 6 further comprising:
a first wheel affixed to a distal end of said first arm; and
a second wheel affixed to a distal end of said second arm.

12. The duct coating applicator according to claim 11 further comprising:
an extension spring having a first end affixed to said outer member and a second end affixed to said extension slider for biasing said extension slider towards said inlet end of said cylindrical body, thereby biasing said first wheel and said second wheel away from said cylindrical body via scissor action of said first arm and said second arm.

13. A method of sealing pipes or ducts comprising the steps of:
mounting a camera on a duct coating applicator;
moving said duct coating applicator through a duct;
recording a video of an inside of said duct;
reviewing said video with a customer proximate a location of said duct and proximate in time to said step of recording;
moving said duct coating applicator through said duct for spraying plural compounds on an interior of said duct for sealing and providing structural integrity to said duct.

14. The method according to claim 13 further comprising:
transmitting said video to a remotely located franchisee and franchisor;
transmitting job statistics to said remotely located franchisee and franchisor.

15. The method according to claim 13 further comprising:
printing a billing statement for said customer proximate said location of said duct.

16. A duct coating system comprising:
a nozzle carriage;
a controller in communication with said nozzle carriage;
a resin tank;
a second fluid tank;
a reservoir in communication with said resin tank;
a reservoir temperature sensor in said resin tank, said reservoir temperature sensor in communication with said controller;
a second reservoir temperature sensor in said second fluid tank, said second reservoir temperature sensor in communication with said controller;
a resin pump in communication with said resin tank;
a second fluid pump in communication with said second fluid tank;
a resin supply line for receiving resin from said resin pump and for delivering said resin to said nozzle carriage;
a second fluid line for receiving a second fluid from said second fluid pump and for delivering said second fluid to said nozzle carriage;
a compressor;
a compressed air line for receiving compressed air from said compressor and for delivering said compressed air to said nozzle carriage;
a resin pressure sensor in communication with said resin supply line for measuring pressure in said resin supply line, said resin pressure sensor in communication with said controller;
a duct diameter proximity sensor on said nozzle carriage for measuring a diameter of a duct through which said nozzle carriage is traversing, said duct diameter proximity sensor in communication with said controller;
a video camera on said nozzle carriage;
a video display for receiving a video signal from said video camera;
a video recorder for receiving said video signal from said video camera;
a data signal cable communicating said video camera with said video display and said video recorder;
a winch engaging said resin supply line, said second fluid line, said compressed air line, and said data signal cable for pulling said nozzle carriage through said duct;
a carriage variable speed drive in communication with said winch for directing a speed with which said winch pulls said nozzle carriage, said carriage variable speed drive receiving a carriage speed signal from said controller.

17. A duct coating system according to claim 16 further comprising:
a remote job statistics collection computer;
an external communicator in communication with said controller for passing job statistics to said remote job statistics collection computer.

18. The duct coating system of claim 16, wherein the controller provides a pump control signal for a pump speed setting of said pump and a speed control signal for a carriage speed setting of said carriage variable speed drive, the controller providing a feed forward system wherein the pump control signal is adjusted based upon the speed control signal and a measured duct diameter from the duct diameter proximity sensor to maintain a predetermined resin thickness applied to a wall of said duct.
